(19) United States
(12) Patent Application Publication
(10) Pub. No.: US 2022/0335964 A1
(43) Pub. Date: Oct. 20, 2022

(54) MODEL GENERATION METHOD, MODEL GENERATION APPARATUS, AND PROGRAM

(71) Applicant: NEC Corporation, Manto-ku, Tokyo (JP)

(72) Inventor: Yu KIYOKAWA, Tokyo (JP)

(73) Assignee: NEC Corporation, Minato-ku, Tokyo (JP)

(21) Appl. No.: 17/763,374

(22) PCT Filed: Oct. 15, 2019
(86) PCT No.: PCT/JP2019/040514

§ 371 Date: Mar. 24, 2022

(51) Int. Cl. G10L 21/0208; G10L 15/06

(52) U.S. Cl. CPC G10L 21/0208; G10L 15/063

(57) ABSTRACT

A model generation apparatus according to the present invention includes: a data generating unit configured to generate, from actual data of acoustic data, replacement data obtained by replacing a predetermined value in the actual data with a replacement value that is a different value from the predetermined value; and a learning unit configured to learn by using the actual data of the acoustic data and the replacement data, and generate a model for removing noise from predetermined acoustic data.

### TECHNICAL FIELD

The present invention relates to a method, apparatus, and program for generating a model for removing noise from acoustic data.

### BACKGROUND ART

In plants such as a manufacturing factory and a processing facility, an acoustic data analysis process may be performed, such as detection of a specific event such as an anomaly occurring in a plant from acoustic data collected in the plant. Then, in a case where the acoustic data contains noise, it is desirable to perform a noise reduction process such as suppression or reduction of noise in order to increase the precision of the analysis of the acoustic data.

As a method for removing noise from acoustic data, a method as described below can be considered. First, as a noise reduction method, a method of separating signals based on the difference in statistical model between acoustic data to be analyzed and noise can be considered. As another method, it can also be considered to perform a filtering process such as smoothing of acoustic data or use of a high-pass filter.
Patent Document 1: Japanese Unexamined Patent Application Publication No. JP-A 2004-012884

However, the noise reduction method as described above has a problem as stated below. First, in a case where a specific event to be detected in the analysis process is, for example, an anomalous state that has a low frequency of occurrence and is unsteady, there arises a problem that acoustic data thereof is hard to be represented by an effective statistical model. In the first place, it is difficult to obtain a statistical model of actual acoustic data and noise. furthermore, acoustic data may not have formants unlike human voice, which makes it difficult to obtain a statistical model. Thus, by the abovementioned noise reduction method using a statistical model, it is difficult to obtain an effective statistical model that clearly shows the difference between acoustic data and noise and it is therefore impossible to remove noise with high precision.

Further, in the filtering process such as smoothing of acoustic data or use of a high-pass filter, a signal of a specific band is removed and therefore acoustic data itself is deteriorated. That is to say, it is impossible to remove only noise from acoustic data with high precision.

### SUMMARY

Accordingly, an object of the present invention is to provide a method, apparatus, and program for solving the abovementioned problem that it is impossible to remove noise from acoustic data with high precision.

A model generation method as an aspect of the present invention includes: generating, from actual data of acoustic data, replacement data obtained by replacing a predetermined value in the actual data with a replacement value that is a different value from the predetermined value; and learning by using the actual data of the acoustic data and the replacement data, and generating a model for removing noise from predetermined acoustic data.

Further, a model generation apparatus as an aspect of the present invention includes: a data generating unit configured to generate, from actual data of acoustic data, replacement data obtained by replacing a predetermined value in the actual data with a replacement value that is a different value from the predetermined value; and a learning unit configured to learn by using the actual data of the acoustic data and the replacement data, and generate a model for removing noise from predetermined acoustic data.

Further, a program as an aspect of the present invention includes instructions for causing an information processing apparatus to realize: a data generating unit configured to generate, from actual data of acoustic data, replacement data obtained by replacing a predetermined value in the actual data with a replacement value that is a different value from the predetermined value; and a learning unit configured to learn by using the actual data of the acoustic data and the replacement data, and generate a model for removing noise from predetermined acoustic data.

With the configurations as described above, the present invention makes it possible to remove noise from acoustic data with precision.

### BRIEF DESCRIPTION OF DRAWINGS

FIG. 1 is a block diagram showing a configuration of a noise reduction apparatus in a first example embodiment of the present invention;

FIG. 2 is a view showing an image of processing when the noise reduction apparatus disclosed in FIG. 1 generates a model for noise reduction;

FIG. 3 is a view showing an image of processing when the noise reduction apparatus disclosed in FIG. 1 generates a model for noise reduction;

FIG. 4 is a view showing an image of processing when the noise reduction apparatus disclosed in FIG. 1 generates a model for noise reduction;

FIG. 5 is a view showing an image of processing when the noise reduction apparatus disclosed in FIG. 1 generates a model for noise reduction;

FIG. 6 is a view showing an image of processing when the noise reduction apparatus disclosed in FIG. 1 generates a model for noise reduction;

FIG. 7 is a flowchart showing an operation when the noise reduction apparatus disclosed in FIG. 1 generates a model for noise reduction;

FIG. 8 is a flowchart showing an operation when the noise reduction apparatus disclosed in FIG. 1 removes noise from acoustic data by using a model for noise reduction;

FIG. 9 is a view showing a result of processing acoustic data by using a model for noise reduction generated by the noise reduction apparatus disclosed in FIG. 1;

FIG. 10 is a view showing a result of processing acoustic data by using a model for noise reduction generated by the noise reduction apparatus disclosed in FIG. 1;

FIG. 11 is a view showing a result of processing acoustic data by using a model for noise reduction generated by the noise reduction apparatus disclosed in FIG. 1;

FIG. 12 is a block diagram showing a hardware configuration of a noise reduction apparatus in a second example embodiment of the present invention;

FIG. 13 is a block diagram showing a configuration of the noise reduction apparatus in the second example embodiment of the present invention; and

FIG. 14 is a flowchart showing an operation of the noise reduction apparatus in the second example embodiment of the present invention.

### EXAMPLE EMBODIMENTS

### First Example Embodiment

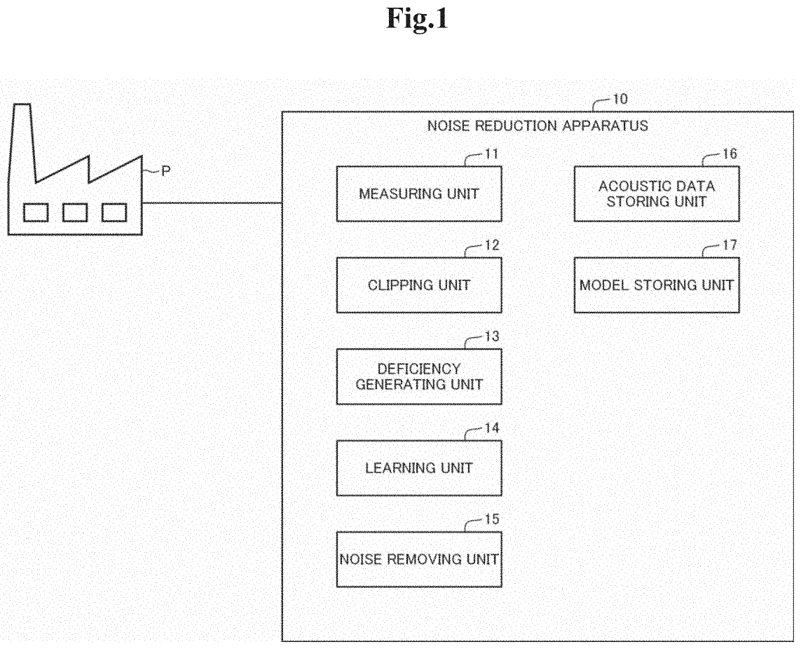

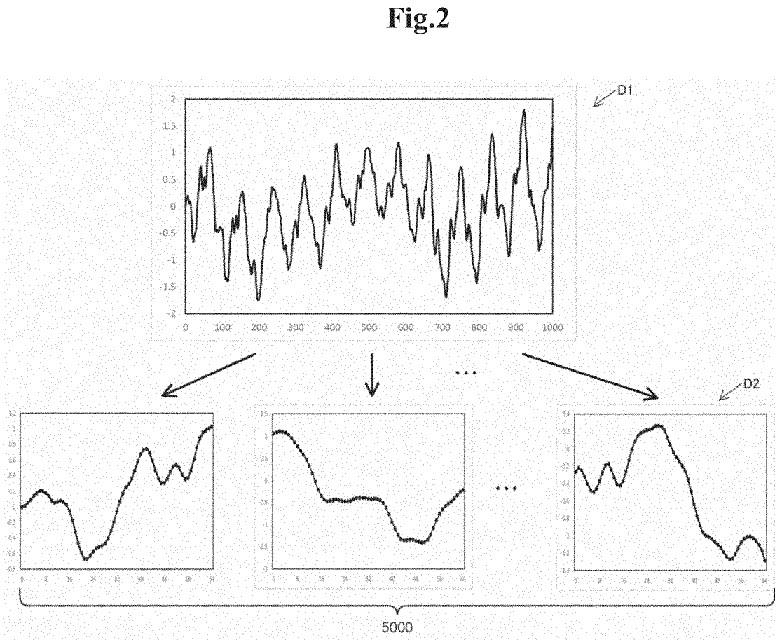

A first example embodiment of the present invention will be described with reference to FIGS. 1 to 11. FIG. 1 is a view for describing a configuration of a noise reduction apparatus, and FIGS. 2 to 11 are views for describing a processing operation of the noise reduction apparatus.

### [Configuration]

A noise reduction apparatus 10 in this example embodiment is connected to a monitoring target P such as a plant. The noise reduction apparatus 10 functions as a model generation apparatus that acquires acoustic data such as machine sound in a plant measured with a microphone installed in the monitoring target P and generates a model for removing noise from the acoustic data. The noise reduction apparatus 10 also functions to remove noise from measured acoustic data by using the generated model.

The noise reduction apparatus 10 outputs the acoustic data from which the noise has been removed to an analysis apparatus (not shown), the acoustic data is analyzed by the analysis apparatus, and the state of the monitoring target P is monitored based on the result of the analysis. For example, the analysis apparatus can analyze the acoustic data from which the noise has been removed to detect that the monitoring target P is in a specific state such as occurrence of an anomaly.

However, the noise reduction apparatus 10 is not necessarily limited to handling acoustic data measured from a plant as a processing target, and may handle any acoustic data measured at any place as a processing target. For example, it is desirable that the noise reduction apparatus 10 in this example embodiment handles, as a processing target, acoustic data such as acoustic data that cannot be reproduced, acoustic data that cannot be tried more times, and acoustic data in which measurement of only noise at a measurement place is impossible, but may handle any acoustic data as a processing target. Moreover, the apparatus in this example embodiment does not always need to perform the process of removing noise from acoustic data, and may perform only the process of generating a model for removing noise from acoustic data as a model generation apparatus.

The noise reduction apparatus 10 includes one or more information processing apparatuses including an arithmetic device and a storage device. Then, the noise reduction apparatus 10 includes, as shown in FIG. 1, a measuring unit 11, a clipping unit 12, a deficiency generating unit 13, a learning unit 14, and a noise removing unit 15, which are structured by the arithmetic device executing a program. The noise reduction apparatus 10 also includes an acoustic data storing unit 16 and a model storing unit 17, which are formed in the storage device. The respective components will be described in detail below.

The measuring unit 11 acquires acoustic data, which is a sound signal measured by a single microphone installed in the monitoring target P, and stores the acoustic data into the acoustic data storing unit 16. For example, the measuring unit 11 acquires acoustic data measured at a sampling frequency of 44.1 kHz and, for example, as shown by reference numeral D1 in FIG. 2, acquires acoustic data of digital data in which the number of samplings is plotted on the horizontal axis and amplitude is plotted on the vertical axis. The example of reference numeral D1 in FIG. 2 illustrates only acoustic data corresponding to a period for 1000 sampling points, but a period of acoustic data to acquire is not limited to such a period. The measuring unit 11 is not always necessary, and acoustic data may be stored in the acoustic data storing unit 16 in advance.

The clipping unit 12 (data generating unit) performs a process of dividing and clipping the acoustic data stored in the acoustic data storing unit 16 for each predetermined period to generate a plurality of acoustic data of predetermined period. As an example, as shown in FIG. 2, the clipping unit 12 generates 5000 pieces of division acoustic data D2 (actual data) obtained by dividing acoustic data D1 for 1000 sampling points by a period for 64 sampling points. At this time, the clipping unit 12 generates the division acoustic data D2 randomly clipped off the acoustic data D1 by a period for 64 consecutive sampling points. The periods of the plurality of division acoustic data D2 generated by the clipping unit 12 may overlap each other in the original acoustic data D1. For example, it is possible to prepare a window of a predetermined period for, for example, 64 sampling points and clip the acoustic data in the window as the division acoustic data D2 while moving the window.

Here, the clipping unit 12 is not necessarily limited to generating the division acoustic data D2 for the abovementioned period (64 points), and may generate the division acoustic data D2 for any period. Moreover, the clipping unit 12 does not necessarily need to generate 5000 pieces of division acoustic data, and may generate any number of division acoustic data. Alternatively, the clipping 12 is not always necessary, and it is possible to prepare a plurality of acoustic data measured by the measuring unit 11 or acoustic data stored in advance, and use as the abovementioned division acoustic data D2.

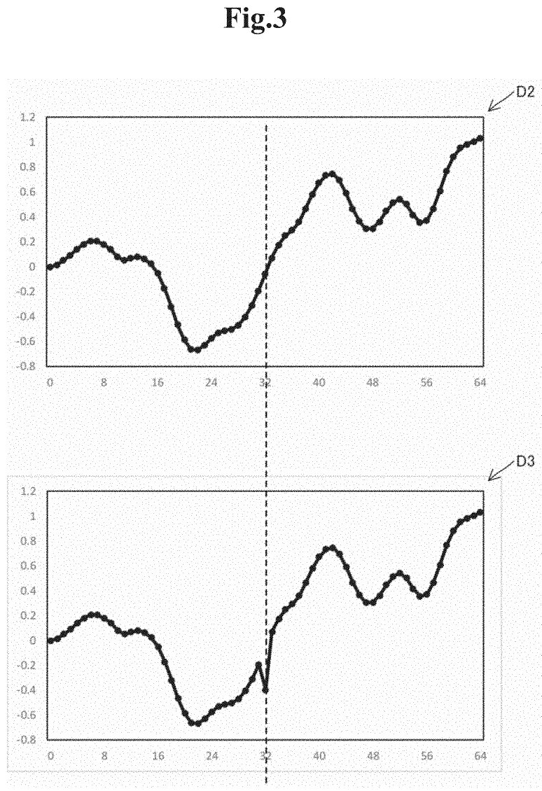

The deficiency generating unit 13 (data generating unit) generates missing data D3 (replacement data) in which its value is partly missing from each division acoustic data D2 (actual data) generated in the abovementioned manner. As an example, the deficiency generating unit 13 replaces an amplitude value (a predetermined value) at a predetermined sampling point (predetermined time point) in the division acoustic data D2 shown in the upper part of FIG. 3 with a missing value (replacement value), which is a different value from an actual value, to generate the missing data D3 shown in the lower part of FIG. 3. At this time, the missing value may be any value, but it is also possible to calculate and use the average value of values in the same division acoustic data D2 or copy and use another value as the missing value, for example. Although the missing value in this example embodiment may be “0”, it is not necessarily limited to a value nullifying an amplitude value, such as “0”, and may be any value that is different from an amplitude value at a predetermined sampling point in the division acoustic data D2 that is actual data.

Further, the deficiency generating unit 13 generates the missing data D3 by replacing only an amplitude value at one sampling point with the missing value in one division acoustic data D2. For example, in the example of FIG. 3, in the division acoustic data D2 whose period is for 64 sampling points, only an amplitude value at the 32^{nd} sampling is replaced with the missing value. However, the deficiency generating unit 13 is not necessarily limited to replacing only an amplitude value at one sampling point with the missing value in one division acoustic data D2. The deficiency generating unit 13 may replace amplitude values at a plurality of sampling points with the missing value, respectively, in one division acoustic data D2.

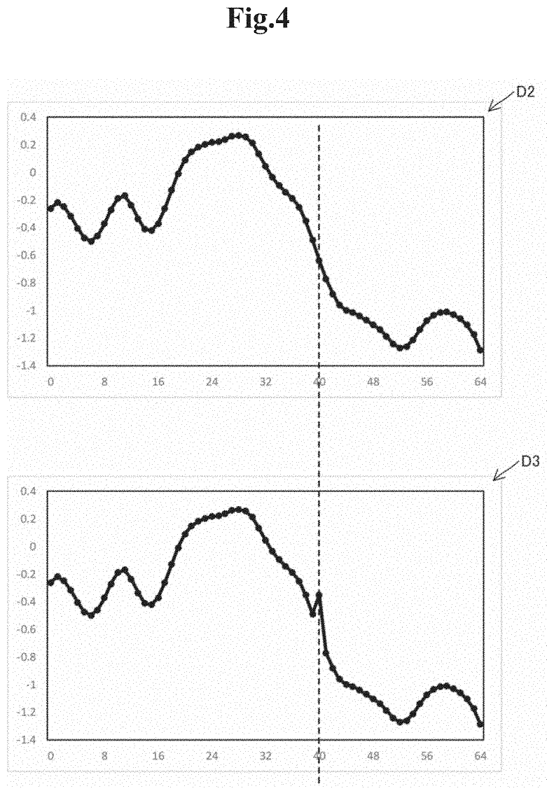

Then, the deficiency generating unit 13 replaces one amplitude value with the missing value for each division acoustic data D2 in the same manner as described above to generate each missing data D3 corresponding to each division acoustic data D2. At this time, the deficiency generating unit 13 replaces, for the respective division acoustic data D2, amplitude values at different sampling points on the original acoustic data D1 before division with the missing value. For example, in an example of FIG. 4, in the division acoustic data D2 whose period is for 64 sampling points, only an amplitude value at the 40^{th} sampling is replaced with the missing value. The period of the division acoustic data D2 having been clipped is different from that in the example of FIG. 3, but even if the division acoustic data D2 are identical, amplitude values at different sampling points are consequently replaced with the missing value. However, the deficiency generating unit 13 randomly determines a sampling point to replace with the missing value in each division acoustic data D2 to consequently prevent the occurrence of redundant replacement of values at many sampling points with the missing value.

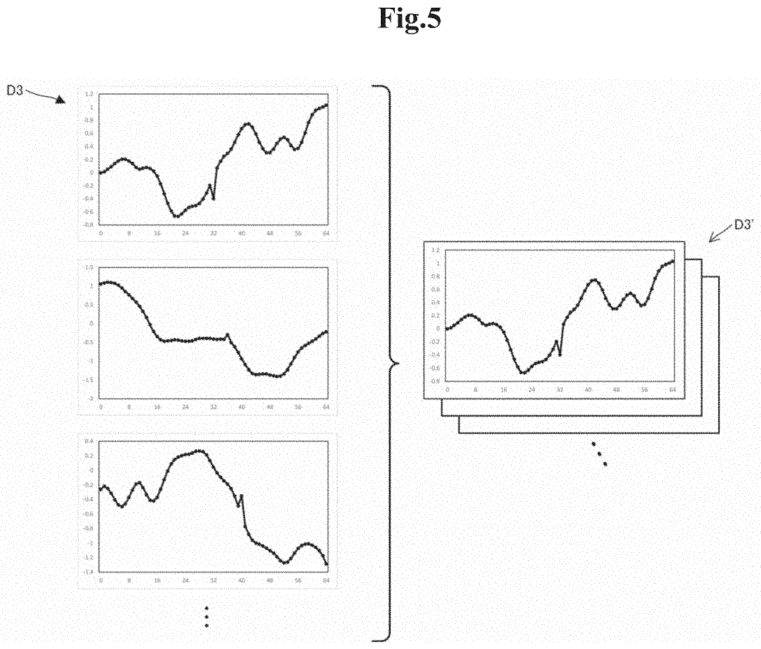

The learning unit 14 performs network learning by using the division acoustic data D2 and the missing data D3 generated in the abovementioned manner, and generates a model for removing noise from predetermined acoustic data. Specifically, the learning unit 14 first generates a missing data set D3′, which is a collection of a plurality of missing data D3. At this time, as shown in FIG. 5, the learning unit 14 generates a missing data set D3′ including a combination of a plurality of missing data D3 in which values at different sampling points are replaced with the missing value. As an example, the learning unit 14 generates one missing data set D3′ from 100 pieces of missing data D3.

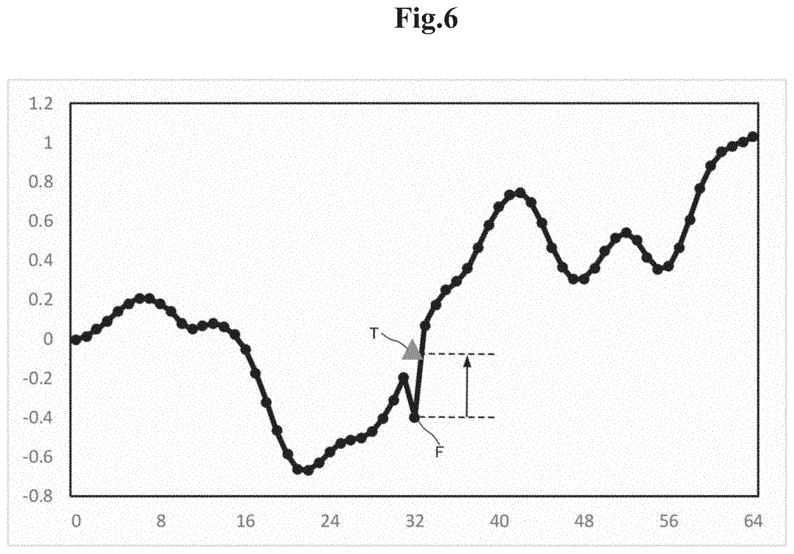

Then, the learning unit 14 uses a plurality of missing data D3 included in the missing data set D3′ as an input value to input into a model at one time, and performs learning by using the plurality of missing data D3 together. Specifically, the learning unit 14 performs network learning so as to predict and output, for each missing data D3 in the missing data set D3′, a value that makes an amplitude value at a sampling point replaced with the missing value in the missing data D3 closer to an amplitude value in the division acoustic data D2 before replacement with the missing value. For example, in an example of FIG. 6, the learning unit 14 performs learning so as to output a value that makes a missing value F closer to a value T of the actual data before replacement with the missing value as indicated by an arrow. At this time, the learning unit 14 performs learning so as to predict the value T of the actual data before replacement with the missing value F from an amplitude value other than the missing value F of the missing data D3.

Prior to the abovementioned learning, the learning unit 14 calculates a loss value, which is the difference between the missing value in the missing data D3 and the value T of the actual data before replacement with the missing value F in the corresponding division acoustic data D2. Then, the learning unit 14 learns a model for predicting a value that minimizes a loss value with respect to the value T of the actual data as a value at a sampling point replaced with the missing value in the missing data D2.

Thus, the learning unit 14 uses a plurality of missing data sets D3′ as an input to learn about a large number of missing data D3, and thereby generates a model for predicting a value at a sampling point replaced with a missing value. Then, the learning unit 14 stores the generated model into the model storing unit 17. The model generated in this manner has a function of removing a missing value, and can be applied to noise reduction.

The noise removing unit 15 removes noise in predetermined acoustic data by using the model stored in the model storing unit 17. Specifically, the noise removing unit 15 first acquires acoustic data in the monitoring target P measured by the measuring unit 11 as described above. The noise removing unit 15 then retrieves the model stored in the model storing unit 17, inputs the acquired acoustic data into the model, and acquires an output thereof. Then, the noise removing unit 15 can acquire the acoustic data from which the noise has been removed as the output. The noise removing unit 15 outputs the output acoustic data to a predetermined analyzing apparatus or stores the output acoustic data for analysis.

### [Operation]

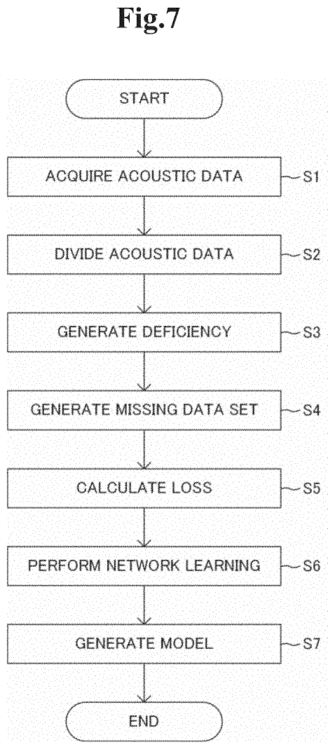

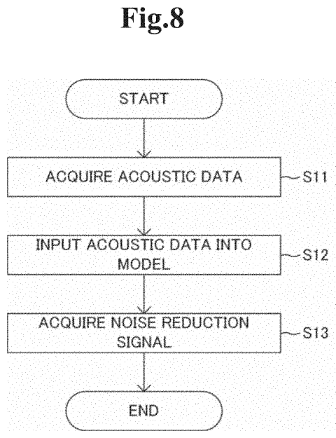

Next, an operation of the above noise reduction apparatus 10 will be described majorly with reference to flowcharts shown in FIGS. 7 and 8. First, an operation when the noise reduction apparatus 10 works as a model generation apparatus and generates a model for removing noise of acoustic data will be described with reference to the flowchart of FIG. 7.

The noise reduction apparatus 10 acquires the acoustic data D1, which is a sound signal measured by a single microphone installed in the monitoring target P (step S1). Then, the noise reduction apparatus 10 randomly divides the acoustic data D1 by a period for a constant number of samplings to generate a plurality of division acoustic data D2 as shown in FIG. 2 (step S2).

Subsequently, the noise reduction apparatus 10 makes the amplitude values of each of the division acoustic data D2 partly missing to generate the missing data D3 corresponding to the division acoustic data D2 (step S3). At this time, the noise reduction apparatus 10 generates, for one of the division acoustic data D2, the missing data D3 by replacing only an amplitude value at one sampling point with a missing value. Furthermore, the noise reduction apparatus 10 replaces, for the respective division acoustic data D2, amplitude values at different sampling points on the original acoustic data D1 before division with the missing value to generate the missing data D3. For example, the noise reduction apparatus 10 generates the missing data D3 as shown in the lower views of FIGS. 3 and 4.

Subsequently, the noise reduction apparatus 10 generates the missing data set D3′ including a combination of a plurality of missing data D3 (step S4). At this time, the noise reduction apparatus 10 generates the missing data set D3′ including a plurality of missing data D3 in which values at different sampling points are replaced with the missing value.

Subsequently, the noise reduction apparatus 10 calculates, for each of the missing data D3 in each missing data set D3′, a loss value that is the difference between the missing value in the missing data D3 and the value T of actual data before replacement with the missing value F in the corresponding division acoustic data D2 (step S5).

Then, the noise reduction apparatus 10 performs network learning by using the missing data D3 and the loss value (step S6). Specifically, the noise reduction apparatus 10 performs network learning of a model so as to, by using a plurality of missing data D3 included in the missing data set D3′ as an input value to input at one time, predict a value minimizing a loss value with respect to the value of actual data before replacement with a missing value as a value at a sampling point after replacement with a missing value in each of the missing data D3. That is to say, the noise reduction apparatus 10 performs learning so as to, for a missing value in the input missing data D3, make a value at a sampling point after replacement with the missing value in the missing data D3 a teacher signal. With this, a model to be generated is learned so as to predict, as a value at a sampling point after replacement with a missing value in the missing data D3, the value of actual data before replacement with a missing value.

Then, the noise reduction apparatus 10 learns about a large number of missing data D3 by using a plurality of missing data sets D3′ as an input, and generates a model for predicting a value at a sampling point after replacement with a missing value (step S7). After that, the noise reduction apparatus 10 stores the generated model into the model storing unit 17.

The model generated in the abovementioned manner has a function of removing a missing value from acoustic data and can be applied to noise reduction.

Next, an operation when the noise reduction apparatus 10 removes noise of predetermined acoustic data by using a model will be described with reference to the flowchart of FIG. 8. First, the noise reduction apparatus 10 acquires acoustic data in the monitoring target P measured by the measuring unit 11 (step S11). Then, the noise reduction apparatus 10 inputs the acquired acoustic data into the model stored in the model storing unit 17 (step S12), and acquires an output thereof (step S13). Then, the noise reduction apparatus 10 outputs the output acoustic data to a predetermined analyzing apparatus or stores the output acoustic data for analysis.

Thus, since the noise reduction apparatus 10 in this example embodiment makes acoustic data missing and generates a model learned so as to predict the value of actual data before made to be missing as the value of the deficiency, noise can be precisely removed from acoustic data by using the model. Therefore, it is possible to precisely remove noise from even acoustic data such as acoustic data that cannot be reproduced, acoustic data that cannot be tried more times, and acoustic data in which it is impossible to measure only noise at a measurement place. Then, by performing various analyses using acoustic data from which noise has been removed, it is possible to increase the analysis precision. For example, it is possible to use for detecting the occurrence of a specific event such as an anomaly from acoustic data measured in a plant or the like.

Then, in this example embodiment, particularly, an amplitude value at one sampling point in one division acoustic data D2 is made to be missing, and a model for predicting the value of the missing point from the value of actual data of another point is generated. With this, since it is possible to generate a model that calculates one prediction value from a plurality of values, it is possible to generate a model that more effectively predicts the value of a missing point, and it is possible to effectively perform noise reduction.

Further, a plurality of division acoustic data D2 having different missing points are learned together in this example embodiment. Therefore, it is possible to generate a model that can appropriately correspond to every acoustic data, and it is possible to more effectively perform noise reduction.

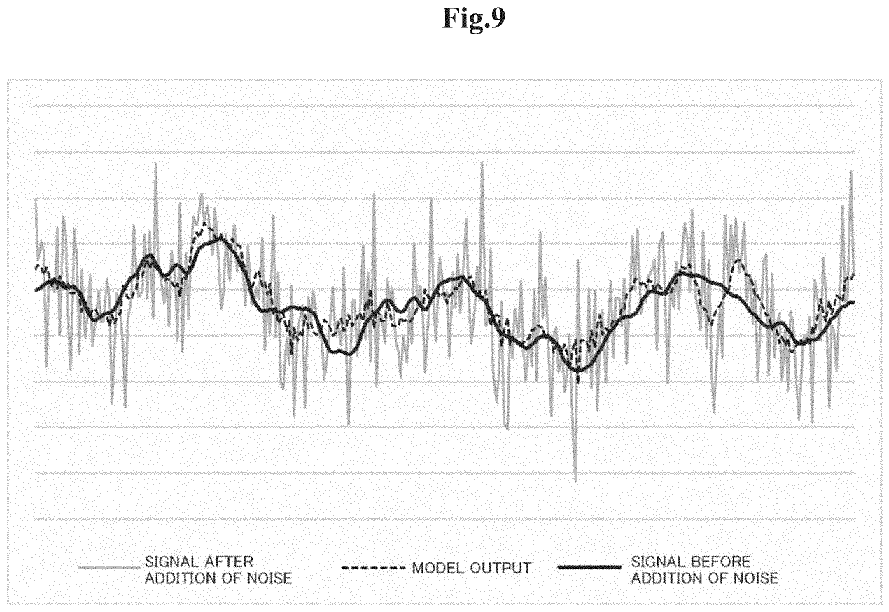

Here, a case where noise reduction is actually performed using a model generated by the noise reduction apparatus 10 in this example embodiment will be described with reference to FIGS. 9 to 11. First, a graph of FIG. 9 shows an output (dotted line: model output) when a model is generated by learning using acoustic data to which Gaussian noise is added (gray line: signal after addition of noise) and acoustic data to which the Gaussian noise is added is input into the model, and acoustic data before the Gaussian noise is added (black solid line: signal before addition of noise). Looking at this graph, it can be said that the model output reproduces the signal before addition of noise to some extent, and it can be seen that the noise is appropriately removed.

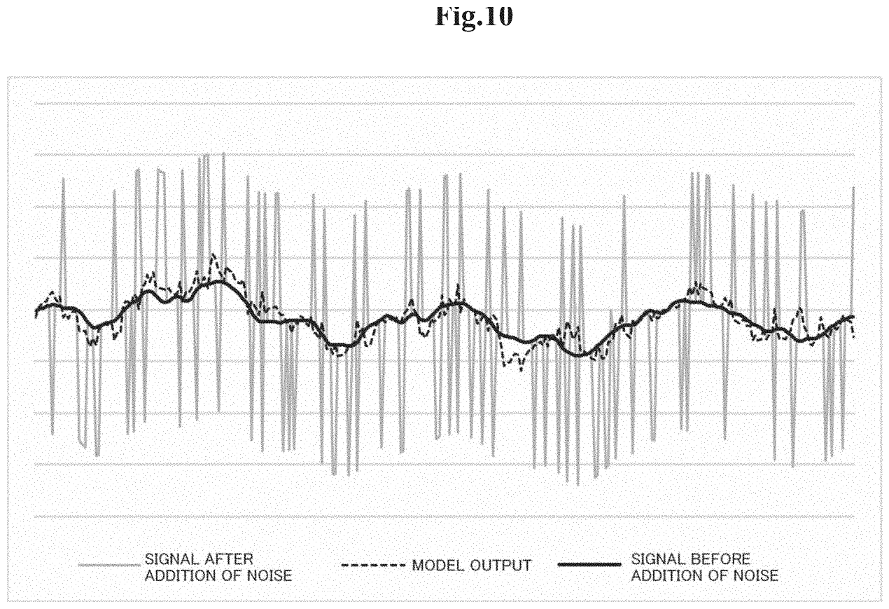

Next, a graph of FIG. 10 shows an output (dotted line: model output) when a model is generated by learning using acoustic data to which a random impulse signal is added as noise (gray line: signal after addition of noise) and acoustic data to which random pulse noise is added is input into the model, and acoustic data before noise is added (black solid line: signal before addition of noise). Looking at this graph, it can be said that the model output reproduces the signal before addition of noise to some extent, and it can be seen that noise is appropriately removed.

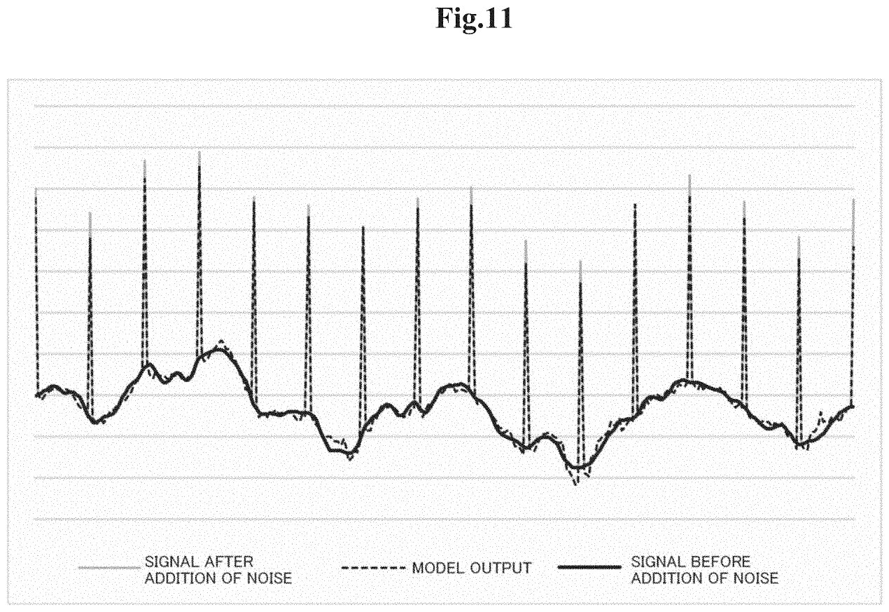

Next, a graph of FIG. 11 shows an output (dotted line: model output) when a model is generated by learning using acoustic data to which a periodic impulse signal is added as noise (gray line: signal after addition of noise) and acoustic data to which periodic impulse signal noise is added is input into the model, and acoustic data before addition of noise (black solid line: signal before addition of noise). Looking at this graph, it cannot be said that the model output reproduces the signal before addition of noise. That is to say, even if the model generated by the method of this example embodiment is used, the periodic impulse signal is not removed as noise. With this, in an environment that a periodic impulse signal by a machine such as a motor is caused in a normal state in a facility such as a plant, the periodic impulse signal is not removed. Therefore, it is possible to avoid unnecessarily removing a signal in a normal state from acoustic data, and it is possible to appropriately remove only noise. As a result, acoustic data from which noise is removed with precision can be acquired.

### Second Example Embodiment

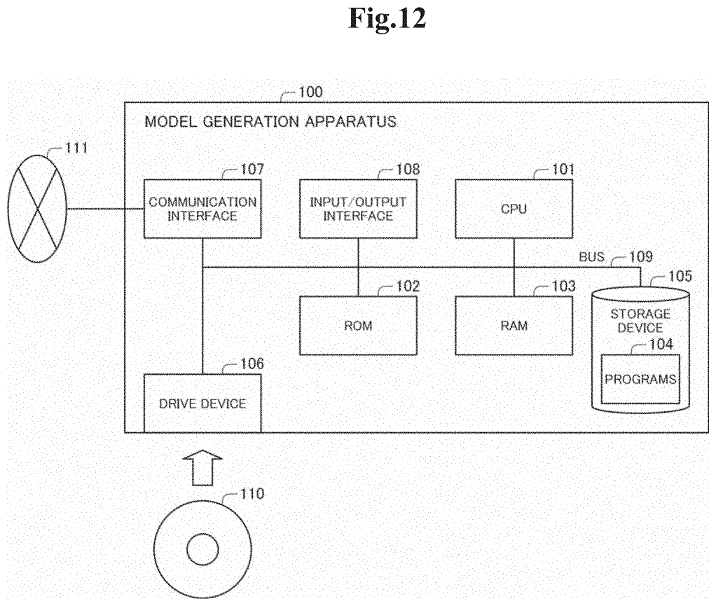

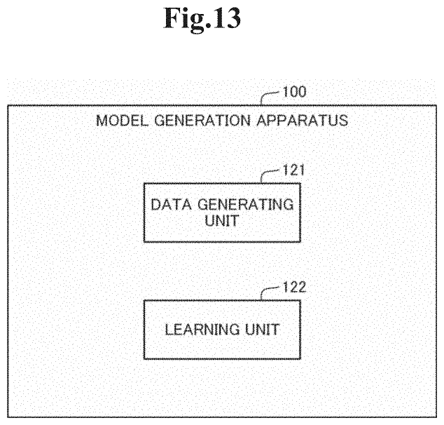

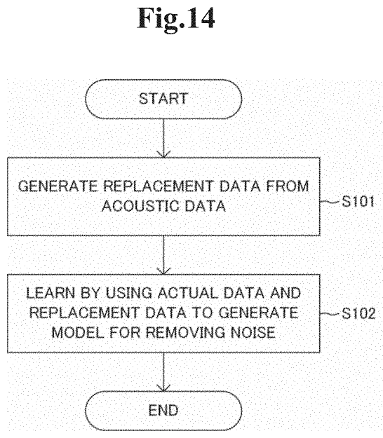

Next, a second example embodiment of the present invention will be described with reference to FIGS. 12 to 14. FIGS. 12 and 13 are block diagrams showing a configuration of a model generation apparatus in the second example embodiment, and FIG. 14 is a flowchart showing an operation of the model generation apparatus. In this example embodiment, the overview of the configurations of the model generation apparatus and the model generation method described in the above example embodiment is shown.

First, a hardware configuration of a model generation apparatus 100 in this example embodiment will be described with reference to FIG. 12. The model generation apparatus 100 is configured by a general information processing apparatus and, as an example, has a hardware configuration as shown below;

CPU (Central Processing Unit) 101 (arithmetic device),

ROM (Read Only Memory) 102 (storage device),

RAM (Random Access Memory) 103 (storage device),

Programs 104 loaded to the RAM 103,

Storage device 105 for storing the programs 104,

Drive device 106 reading from and writing into a storage medium 110 outside the information processing apparatus,

Communication interface 107 connected to a communication network 111 outside the information processing apparatus,

Input/output interface 108 inputting and outputting data, and

Bus 109 connecting the respective components.

The model generation apparatus 100 can structure and include a data generating unit 121 and a learning unit 122 shown in FIG. 19 by acquisition and execution of the programs 104 by the CPU 101. The programs 104 are, for example, stored in the storage device 105 or the ROM 102 in advance, and are loaded to the RAM 103 and executed by the CPU 101 as necessary. The programs 104 may also be supplied to the CPU 101 via the communication network 111, or may be stored in the storage medium 110 in advance and retrieved and supplied to the CPU 101 by the drive device 106. However, the abovementioned data generating unit 121 and learning unit 122 may be structured by electronic circuits.

FIG. 12 shows an example of the hardware configuration of the information processing apparatus serving as the model generation apparatus 100, and the hardware configuration of the information processing apparatus is not limited to the abovementioned case. For example, the information processing apparatus may include part of the abovementioned configuration, for example, a configuration without the drive device 106.

The model generation apparatus 100 executes a model generation method shown in the flowchart of FIG. 14 by the functions of the data generating unit 121 and the learning unit 122 structured by the programs as described above.

As shown in FIG. 14, the model generation apparatus 100: generates, from actual data of acoustic data, replacement data obtained by replacing a predetermined value in the actual data with a replacement value that is a value different from the predetermined value (step S101); and performs learning by using the actual data of the acoustic data and the replacement data to generate a model for removing noise from predetermined acoustic data (step S102).

With the configurations as described above, the model generation apparatus 100 and the model generation method in this example embodiment replace a predetermined value in acoustic data with a replacement value and generate a model for removing noise from acoustic data by using the replacement data and actual data. Therefore, the generated model has a function of removing the replacement value and can also be applied to noise reduction. As a result, it is possible to precisely remove noise from even acoustic data such as acoustic data that cannot be reproduced, acoustic data that cannot be tried more times, and acoustic data in which it is impossible to measure only noise at a measurement place.

### <Supplementary Notes>

The whole or part of the example embodiments disclosed above can be described as the following supplementary notes. The overview of the configurations of a model generation method, a model generation apparatus, and a program according to the present invention will be described below. However, the present invention is not limited to the following configurations.

### (Supplementary Note 1)

A model generation method comprising:

generating replacement data from actual data of acoustic data, the replacement data being obtained by replacing a predetermined value in the actual data with a replacement value that is a different value from the predetermined value; and

learning by using the actual data of the acoustic data and the replacement data, and generating a model for removing noise from predetermined acoustic data.

### (Supplementary Note 2)

The model generation method according to Supplementary Note 1, comprising by using the actual data of the acoustic data and the replacement data, generating the model for predicting the actual data from the replacement data.

### (Supplementary Note 3)

The model generation method according to Supplementary Note 1 or 2, comprising

generating the model for predicting the predetermined value in the actual data replaced with the replacement value from the replacement data.

### (Supplementary Note 4)

The model generation method according to any of Supplementary Notes 1 to 3, comprising

calculating a difference between the replacement value and the predetermined value in the actual data replaced with the replacement value as a loss value, and generating the model for predicting the predetermined value in the actual data replaced with the replacement value based on the replacement data and the loss value.

### (Supplementary Note 5)

The model generation method according to any of Supplementary Notes 1 to 4, comprising

for the actual data for one predetermined period, replacing only the predetermined value at one time point in the actual data with the replacement value to generate the replacement data.

### (Supplementary Note 6)

The model generation method according to any of Supplementary Notes 1 to 5, comprising:

for each of the actual data for a plurality of predetermined periods, replacing the predetermined value at a predetermined time point in the actual data with the replacement value to generate a plurality of replacement data; and

learning based on the plurality of actual data and the plurality of replacement data, and generating the model.

### (Supplementary Note 7)

The model generation method according to Supplementary Note 6, comprising

for the respective actual data for a plurality of predetermined periods, replacing the predetermined values at mutually different time points in the actual data with the replacement value to generate a plurality of replacement data.

### (Supplementary Note 8)

The model generation method according to Supplementary Note 6 or 7, comprising

simultaneously learning the plurality of actual data and the plurality of replacement data respectively corresponding to the plurality of actual data, and generating the model.

### (Supplementary Note 9)

The model generation method according to Supplementary Note 8, comprising

simultaneously learning the plurality of actual data obtained by replacing the predetermined values in the actual data with the replacement value at mutually different time points and the plurality of replacement data, and generating the model.

### (Supplementary Note 10)

A noise reduction method comprising:

generating replacement data from actual data of acoustic data, the replacement data being obtained by replacing a predetermined value in the actual data with a replacement value that is a different value from the predetermined value;

learning by using the actual data of the acoustic data and the replacement data, and generating a model for removing noise from predetermined acoustic data; and

inputting predetermined acoustic data into the generated model, and acquiring an output from the model.

### (Supplementary Note 11)

A model generation apparatus comprising:

a data generating unit configured to generate replacement data from actual data of acoustic data, the replacement data being obtained by replacing a predetermined value in the actual data with a replacement value that is a different value from the predetermined value; and

a learning unit configured to learn by using the actual data of the acoustic data and the replacement data, and generate a model for removing noise from predetermined acoustic data.

### (Supplementary Note 11.1)

The model generation apparatus according to Supplementary Note 11, wherein

the learning unit is configured to, by using the actual data of the acoustic data and the replacement data, generate the model for predicting the actual data from the replacement data.

### (Supplementary Note 11.2)

The model generation apparatus according to Supplementary Note 11 or 11.1, wherein

the learning unit is configured to generate the model for predicting the predetermined value in the actual data replaced with the replacement value from the replacement data.

### (Supplementary Note 11.3)

The model generation apparatus according to any of Supplementary Notes 11 to 11.2, wherein

the learning unit is configured to calculate a difference between the replacement value and the predetermined value in the actual data replaced with the replacement value as a loss value, and generate the model for predicting the predetermined value in the actual data replaced with the replacement value based on the replacement data and the loss value.

### (Supplementary Note 11.4)

The model generation apparatus according to any of Supplementary Notes 11 to 11.3, wherein

the data generating unit is configured to, for the actual data for one predetermined period, replace only the predetermined value at one time point in the actual data with the replacement value to generate the replacement data.

### (Supplementary Note 11.5)

The model generation apparatus according to any of Supplementary Notes 11 to 11.4, wherein:

the data generating unit is configured to, for each of the actual data for a plurality of predetermined periods, replace the predetermined value at a predetermined time point in the actual data with the replacement value to generate a plurality of replacement data; and

the learning unit is configured to learn based on the plurality of actual data and the plurality of replacement data, and generate the model.

### (Supplementary Note 11.6)

The model generation apparatus according to Supplementary Note 11.5, wherein

the data generating unit is configured to, for the respective actual data for a plurality of predetermined periods, replace the predetermined values at mutually different time points in the actual data with the replacement value to generate a plurality of replacement data.

### (Supplementary Note 11.7)

The model generation apparatus according to Supplementary Note 11.5 or 11.6, wherein

the learning unit is configured to simultaneously learn the plurality of actual data and the plurality of replacement data respectively corresponding to the plurality of actual data, and generate the model.

### (Supplementary Note 11.8)

The model generation apparatus according to Supplementary Note 11.7, wherein

the learning unit is configured to simultaneously learn the plurality of actual data obtained by replacing the predetermined values in the actual data with the replacement value at mutually different time points and the plurality of replacement data, and generate the model.

### (Supplementary Note 12)

A noise reduction apparatus comprising:

a data generating unit configured to generate replacement data from actual data of acoustic data, the replacement data being obtained by replacing a predetermined value in the actual data with a replacement value that is a different value from the predetermined value;

a learning unit configured to learn by using the actual data of the acoustic data and the replacement data, and generate a model for removing noise from predetermined acoustic data; and

a noise removing unit configured to input predetermined acoustic data into the generated model, and acquire an output from the model.

### (Supplementary Note 13)

A program comprising instructions for causing an information processing apparatus to realize:

a data generating unit configured to generate replacement data from actual data of acoustic data, the replacement data being obtained by replacing a predetermined value in the actual data with a replacement value that is a different value from the predetermined value; and

a learning unit configured to learn by using the actual data of the acoustic data and the replacement data, and generate a model for removing noise from predetermined acoustic data.

### (Supplementary Note 14)

A program comprising instructions for causing an information processing apparatus to realize:

a data generating unit configured to generate replacement data from actual data of acoustic data, the replacement data being obtained by replacing a predetermined value in the actual data with a replacement value that is a different value from the predetermined value;

a learning unit configured to learn by using the actual data of the acoustic data and the replacement data, and generate a model for removing noise from predetermined acoustic data; and

a noise removing unit configured to input predetermined acoustic data into the generated model, and acquire an output from the model.

The abovementioned program can be stored by using various types of non-transitory computer-readable mediums and supplied to a computer. The non-transitory computer-readable mediums include various types of tangible storage mediums. Examples of the non-transitory computer-readable mediums are a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (Random Access Memory)). The program may also be supplied to a computer by various types of transitory computer-readable mediums. Examples of the transitory computer-readable mediums include electric signals, optical signals, and electromagnetic waves. The transitory computer-readable mediums can supply the program to the computer via a wired communication path such as an electric wire or an optical fiber or via a wireless communication path.

Although the present invention has been described above with reference to the above example embodiments, the present invention is not limited to the example embodiments. The configurations and details of the present invention can be changed in various manners that can be understood by one skilled in the art within the scope of the present invention.

### DESCRIPTION OF NUMERALS

10 noise reduction apparatus
11 measuring unit
12 clipping unit
13 deficiency generating unit
14 learning unit
15 noise removing unit
16 acoustic data storing unit
17 model storing unit
100 model generation apparatus
101 CPU
102 ROM
103 RAM
104 programs
105 storage device
106 drive device
107 communication interface
108 input/output interface
109 bus
110 storage medium
111 communication network
121 data generating unit
122 learning unit

What is claimed is:

1. A model generation method comprising:
generating replacement data from actual data of acoustic data, the replacement data being obtained by replacing a predetermined value in the actual data with a replacement value that is a different value from the predetermined value; and
learning by using the actual data of the acoustic data and the replacement data, and generating a model for removing noise from predetermined acoustic data.

2. The model generation method according to claim 1, comprising
by using the actual data of the acoustic data and the replacement data, generating the model for predicting the actual data from the replacement data.

3. The model generation method according to claim 1, comprising
generating the model for predicting the predetermined value in the actual data replaced with the replacement value from the replacement data.

4. The model generation method according to claim 1, comprising
calculating a difference between the replacement value and the predetermined value in the actual data replaced with the replacement value as a loss value, and generating the model for predicting the predetermined value in the actual data replaced with the replacement value based on the replacement data and the loss value.

5. The model generation method according to claim 1, comprising
for the actual data for one predetermined period, replacing only the predetermined value at one time point in the actual data with the replacement value to generate the replacement data.

6. The model generation method according to claim 1, comprising:
for each of the actual data for a plurality of predetermined periods, replacing the predetermined value at a predetermined time point in the actual data with the replacement value to generate a plurality of replacement data; and
learning based on the plurality of actual data and the plurality of replacement data, and generating the model.

7. The model generation method according to claim 6, comprising
for the respective actual data for a plurality of predetermined periods, replacing the predetermined values at mutually different time points in the actual data with the replacement value to generate a plurality of replacement data.

8. The model generation method according to claim 6, comprising simultaneously learning the plurality of actual data and the plurality of replacement data respectively corresponding to the plurality of actual data, and generating the model.

9. The model generation method according to claim 8, comprising
simultaneously learning the plurality of actual data obtained by replacing the predetermined values in the actual data with the replacement value at mutually different time points and the plurality of replacement data, and generating the model.

10. A noise reduction method comprising:
generating replacement data from actual data of acoustic data, the replacement data being obtained by replacing a predetermined value in the actual data with a replacement value that is a different value from the predetermined value;
learning by using the actual data of the acoustic data and the replacement data, and generating a model for removing noise from predetermined acoustic data; and
inputting predetermined acoustic data into the generated model, and acquiring an output from the model.

11. A model generation apparatus comprising:
at least one memory configured to store instructions; and
at least one processor configured to execute the instructions to:
generate replacement data from actual data of acoustic data, the replacement data being obtained by replacing a predetermined value in the actual data with a replacement value that is a different value from the predetermined value; and
learn by using the actual data of the acoustic data and the replacement data, and generate a model for removing noise from predetermined acoustic data.

12-14. (canceled)
